(19) United States
(12) Patent Application Publication
(10) Pub. No.: US 2026/0154363 A1
(43) Pub. Date: Jun. 4, 2026

(54) OPTIMIZING TRACKING METADATA IN CACHED HTML

(71) Applicant: eBay Inc., San Jose, CA (US)

(72) Inventor: Damodaran CHINGLEPUT SATHYAKUMAR, West Jordan, UT (US)

(21) Appl. No.: 18/966,982

(22) Filed: Dec. 3, 2024

(51) Int. Cl. G06F 16/957

(52) U.S. Cl. CPC G06F 16/9577; G06F 16/9574

(57) ABSTRACT

Some aspects relate to technologies for optimizing tracking metadata for server-rendered Hypertext Markup Language (HTML) to reduce the size of cached HTML. In accordance with some aspects, a server (e.g., an origin server) generates pre-rendered HTML with markers in place of tracking metadata. The server also generates a mapping between the markers and the tracking metadata. The pre-rendered HTML and mapping are cached, for instance, on a local cache of that server and/or one or more other servers (e.g., edge servers). When a server receives a request for content, the server retrieves the pre-rendered HTML and mapping from its local cache and provides the pre-rendered HTML and mapping to the requesting client. When the client renders the content, the interactive elements in the pre-rendered HTML are populated by replacing the markers with tracking metadata using the mapping.

### BACKGROUND

Hypertext Markup Language (HTML) caching is a common practice in software systems to serve data quicker to incoming Hypertext Transfer Protocol (HTTP) requests. Systems cache pre-rendered HTML either as part of their system or on geographically-distributed edge servers. Server-side renderer systems often incorporate heuristics in the form of comments and attributes within the pre-rendered HTML to facilitate downstream processes. In addition to these heuristics, systems often embed tracking metadata into HTML for end-user tracking. The tracking metadata is used by tracking systems for a number of purposes, such as to assess the effectiveness of user features. However, tracking metadata significantly increases the size of the HTML, posing challenges when caching is used.

### SUMMARY

Some aspects of the present technology relate to, among other things, improved HTML caching by optimizing tracking metadata to reduce the size of pre-rendered HTML that is cached relative to conventional HTML caching approaches. In accordance with some aspects, the tracking metadata is optimized during server-side HTML rendering. Given data for web content including tracking metadata, a server renders HTML for the web content such that interactive elements in the pre-rendered HTML have markers as attributes instead of tracking metadata. The server also generates a mapping that identifies tracking metadata elements corresponding to the markers. The pre-rendered HTML with markers and the mapping are cached on any number of servers, which could include the server that performed the HTML rendering, as well as other distributed servers (e.g., edge servers or application servers). When a server receives a request for content from a client device, the server retrieves the pre-rendered HTML and mapping from its local cache and provides the pre-rendered HTML and mapping as a response to the client device. The client device renders the content for presentation using the pre-rendered HTML and mapping. As part of this process, the client device populates interactive elements with tracking metadata by using the mapping to replace markers in the pre-rendered HTML with corresponding elements of the tracking metadata.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example process of generating, caching, and serving pre-rendered HTML and corresponding mappings in accordance with some implementations of the present disclosure;

FIG. 3 provides an example of pre-rendered HTML with markers in place of tracking metadata in accordance with some implementations of the present disclosure;

FIG. 4 provides an example of a mapping for the pre-rendered HTML of FIG. 3 in accordance with some implementations of the present disclosure;

FIG. 5 provides an example of HTML generated by replacing the markers in the pre-rendered HTML of FIG. 3 with tracking metadata using the mapping of FIG. 4 in accordance with some implementations of the present disclosure;

FIG. 6 is a flow diagram showing a method for server-side HTML rendering to provide pre-rendered HTML with markers in place of tracking metadata and a mapping between the markers and the tracking metadata in accordance with some implementations of the present disclosure;

FIG. 7 is a flow diagram showing a method for caching and serving pre-rendered HTML and a corresponding mapping in accordance with some implementations of the present disclosure;

FIG. 8 is a flow diagram showing a method for a client device to render content using pre-rendered HTML and a corresponding mapping in accordance with some implementations of the present disclosure; and

FIG. 9 is a block diagram of an exemplary computing environment suitable for use in implementations of the present disclosure.

### DETAILED DESCRIPTION

### Overview

Hypertext Markup Language (HTML) renderer systems (e.g., using Marko, React, etc.) typically handle the templating (structure) and widget mechanisms (behavior), and also produce data heuristics that are embedded in pre-rendered HTML to aid their re-renders. These systems can render various components that together form an entire view. A component is a single unit or construct with a defined boundary that is able to generate HTML markup (structure), perform formatting (handle styling) and wire on user interaction (via attaching event listeners to the rendered HTML). A component can also re-render itself in response to new data or user behavior and can also have information on how to fetch new data required to re-render itself. The heuristics are used for achieving highly efficient re-rendering of the HTML in response to change in the state of components.

Tracking systems also have a number of heuristics in the form of tracking metadata that are typically embedded into HTML for tracking purposes. Upon a user interaction or a page level event when content is rendered on a user device using the HTML, the tracking metadata is emitted and flushed (e.g., via XmlHttpRequest or Fetch Requests) to downstream systems that log the data. The downstream systems can then perform their own offline processing over this data to generate analytics for a variety of different use cases. For instance, this data helps determine if a component was surfaced, if the user viewed the component, if the user interacted with the component, the amount of time spent on the component, if the component was dismissed or snoozed, or other related components that the user may be interested in, to name a few.

In the context of one time renders for a request-response cycle on the server or on the client (e.g., loading a webpage upon hitting a URL in the browser), the size of the tracking metadata does not meaningfully impact performance. For instance, the tracking metadata is typically compressed when being transferred over networks (e.g., using compression algorithm such as GZIP and Broth) to provide levels of compression that mitigate any need for other optimizations. However, caching of pre-rendered HTML poses a challenge. There are a number of scenarios where caching pre-rendered HTML is used. For instance, caching is often used for systems like Header platforms that have very minimal changes to the rendered output over vast segments of their requests. Caching is also often used for systems like universal renderer systems that require a very fast response time (e.g., less than 50 milliseconds). A further caching scenario involves edge computing where HTML of entire pages are cached at the edge servers based on the different scenarios and use cases (e.g., in the case of content delivery networks (CDNs)).

The amount of tracking metadata that is typically embedded in HTML structures to track user interactions on a given view can form a considerable portion of the HTML size. In cases of caching HTML, the increased size of the pre-rendered HTML from tracking metadata can significantly impact system performance. For instance, the size of the cached HTML per cache key impacts the number of cache entries that the limited cache can hold. As such, the size of the tracking metadata reduces the number of cache entries in a cache. The cache strategy and eviction strategy used by the system are also determined based on the size of each cache entry that is tied to a cache key. Given this, the increased size of the HTML from the tracking metadata adversely impacts these strategies, for instance, by causing more frequent evictions.

Aspects of the technology described herein provide improved HTML caching by optimizing tracking metadata to reduce the size of pre-rendered HTML that is cached relative to conventional HTML caching approaches. In accordance with some aspects described herein, the tracking metadata is optimized during server-side HTML rendering. In particular, given data for web content (including tracking metadata), a server generates pre-rendered HTML by including markers as attributes of interactive elements in place of the tracking metadata. The server also creates a mapping that identifies elements of the tracking metadata corresponding to these markers. The mapping can be embedded in the pre-rendered HTML or provided separate. In some aspects, the server also provides a script for the pre-rendered HTML to facilitate client-side content rendering. The pre-rendered HTML with markers and the mapping are cached on various servers, which can include the server that performed the HTML rendering and other distributed servers such as edge servers or application servers.

When a server receives a request for content from a client device, the server retrieves the pre-rendered HTML and the corresponding mapping from its local cache and provides them to the client device. The client device then renders the content using the pre-rendered HTML and mapping. During this process, the client device populates interactive elements with tracking metadata by using the mapping to replace the markers in the pre-rendered HTML with the corresponding tracking metadata elements. For instance, this can be performed in response to the user device executing a script provided in the pre-rendered HTML. In some aspects, the client device can utilize web workers to handle the process of replacing markers with tracking metadata, allowing the user device to perform this task without impacting the responsiveness of the user interface. This ensures that the interactive elements are correctly annotated with tracking metadata, enabling reliable delivery of tracking data payloads during user interactions with the rendered content.

Aspects of the technology described herein provide a non-conventional and non-generic arrangement for HTML caching that enables a number of improvements over conventional HTML caching. In accordance with the technology described herein, when a server renders HTML, the server includes markers in the pre-rendered HTML in place of tracking metadata and generates a mapping with the tracking metadata. In this way, the technology described herein reduces the size of cached HTML. Instead of caching redundant elements of the tracking metadata throughout the interactive elements of the pre-rendered HTML (as in conventional approaches), the technology described herein can cache elements of the tracking metadata once in the mapping while the pre-rendered HTML includes relatively smaller markers.

The reduced size of the cached HTML allows for an increased number of cache entries relative to conventional HTML caching approaches given the same sized cache. This, in turn, provides performance improvements in terms of caching and eviction strategies. For instance, given an increased number of caching entries in a cache, cache entries need to be evicted for new cache entries less frequently compared to conventional HTML caching.

Experimentation has demonstrated that the HTML caching approach described herein can significantly reduce cache size of pre-rendered HTML by 50% or more depending on the redundancy of tracking metadata elements. Additionally, interactive elements are populated with tracking metadata on the client side, ensuring no loss of tracking metadata captured during user interactions with rendered content. Furthermore, the population of the interactive elements, especially when web workers are employed, does not materially impact performance of rendering the content on the client. Accordingly, the HTML caching approach described herein provides highly optimized HTML caches that address the cache entry size concerns for pre-rendered HTML, while still ensuring reliable delivery of tracking data payloads and no performance degradation.

### Example System for Optimizing Tracking Metadata in Cached HTML

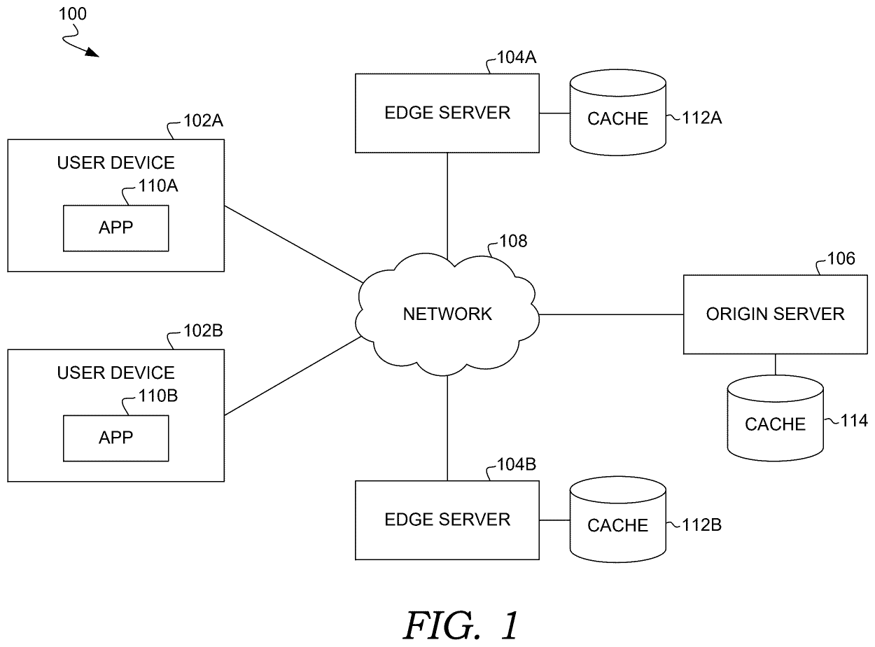

With reference now to the drawings, FIG. 1 is a block diagram illustrating an exemplary system 100 for optimizing tracking metadata in cached HTML to reduce the cached HTML size in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

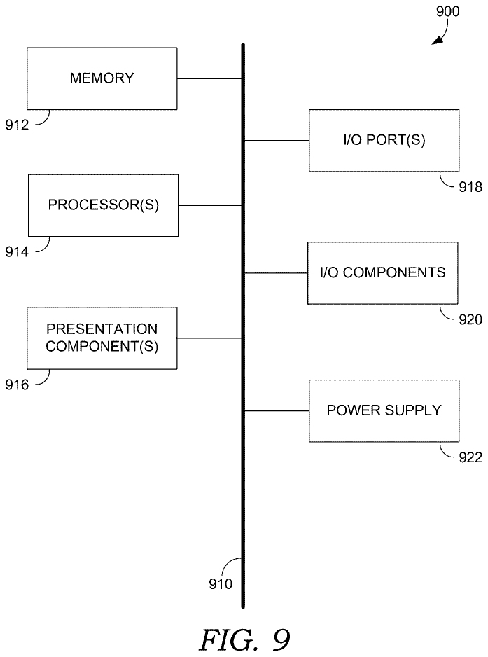

The system 100 is an example of a suitable architecture for implementing certain aspects of the present disclosure. Among other components not shown, the system 100 includes a number of user devices 102, including the user device 102A and the user device 102B, a number of edge servers 104, including the edge server 104A and the edge server 104B, and an origin server 106. Each of the user devices 102, edge servers 104, and origin server 106 shown in FIG. 1 can comprise one or more computer devices, such as the computing device 900 of FIG. 9, discussed below. As shown in FIG. 1, the user devices 102, edge server 104, and origin server 106 can communicate via a network 108, which can include, without limitation, one or more local area networks (LANs) and/or wide area networks (WANs). Such networking environments are commonplace in offices, enterprise-wide computer networks, intranets, and the Internet. It should be understood that any number of user devices 102, edge servers 104, and origin servers 106 can be employed within the system 100 within the scope of the present technology. Each can comprise a single device or multiple devices cooperating in a distributed environment. For instance, each edge server 104 and each origin server 106 could be provided by multiple server devices collectively providing the functionality of each as described herein. Although not shown in FIG. 1, the system 100 can also include one or more application servers and/or other types of servers that can perform caching and content serving similar to that discussed herein below for the edge servers 104. Additionally, other components not shown can also be included within the network environment.

Each user device 102 can be a client device on the client-side of the system 100, while each edge server 104 and the origin server 106 can be on the server-side of the system 100. Each edge server 104 and the origin server 106 can comprise server-side software designed to work in conjunction with client-side software on each user device 102 so as to implement any combination of the features and functionalities discussed in the present disclosure. For instance, each user device 102 can include an application 110 (such as the application 110A on the user device 102A and the application 110B on the user device 102B) for interacting with edge servers 104 and/or the origin server 106. Each application 110 can be, for instance, a web browser or a dedicated application for providing functions, such as those described herein. This division of the system 100 is provided to illustrate one example of a suitable environment. It should be understood that other configurations can be employed in which components are combined.

Each user device 102 can comprise any type of computing device capable of use by a user. For example, in one aspect, each user device 102 can be the type of computing device 900 described in relation to FIG. 9 herein. By way of example and not limitation, each user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user can be associated with each user device 102.

Each edge server 104 and the origin server 106 can be implemented using one or more server devices, one or more platforms with corresponding application programming interfaces, cloud infrastructure, and the like. In one aspect, the functions performed by components of each edge server 104 and the origin server 106 are associated with one or more applications, services, or routines. Such applications, services, or routines can operate on one or more servers, can be distributed across one or more servers, or can be implemented in the cloud. In some aspects, the components of the edge servers 104 and the origin server 106 can be distributed across a network, including one or more servers or in the cloud. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The origin server 106 hosts and serves original versions of web content. While only a single origin server 106 is shown in FIG. 1, the system 100 can include any number of origin servers. In some aspects, the origin server 106 is provided by a server farm having a network of servers. The origin server 106 can be the primary server where web content, such as files, databases, or applications, is stored and managed. The origin server 106 can serve as the authoritative source for data when a network device, such as a user device 102 or an edge server 104, requests access to content. For instance, in a content delivery network (CDN) or caching setup, the origin server 106 is the initial location from which data originates before being distributed to the edge servers 104 for faster delivery to user devices 102.

The origin server 106 has an associated cache 114, which provides temporary storage on or near the origin server 106 that holds frequently accessed data to improve performance and reduce processing demands. The cache 114 can store, for instance, dynamic or static content generated by the origin server 106, such as database query results, application responses, or rendered web pages, enabling faster delivery to clients by avoiding repeated computation or retrieval.

In accordance with aspects of the present technology, the origin server 106 generates and manages pre-rendered HTML and associated mappings. Given data for web content (including the tracking metadata for the web content), the origin server 106 renders pre-rendered HTML. As part of the rendering process, the origin server 106 injects markers in place of tracking metadata as attributes of interactive elements in the pre-rendered HTML. Additionally, the origin server 106 generates a mapping between these markers and elements of the tracking metadata. In some aspects, the mapping comprises a serialized tracking data object that is generated by serializing the tracking metadata.

The pre-rendered HTML and the corresponding mapping are stored in the cache 114 of the origin server 106. In some aspects, the mapping is embedded in the pre-rendered HTML; while in other aspects, the mapping is separate. In some configurations, the origin server 106 also provides a script for execution on user devices 102 to cause the user devices 102 to render content by replacing markers in the pre-rendered HTML with tracking metadata from the mapping. The script can be embedded in the pre-rendered HTML or separate from the pre-renderer HTML and stored in the cache 114 of the origin server 106.

In some configurations, the pre-rendered HTML optimization performed by the origin server 106 can include reading tracking metadata for a given component as it arrives and updating an in-memory tracking object (that will be serialized) with the received tracking metadata. Once the in-memory tracking object is updated with the tracking metadata, the origin server 106 encodes redundant portions of the tracking metadata with markers that serve as specific pointers to the in-memory data. This plain encoding can drastically reduce the size of the tracking metadata by replacing them with the markers. In some instances, the origin server 106 can also prune the tracking metadata by removing duplicate objects/references and also by removing circular references (e.g., a sub-component referencing a parent or a parent referencing a sub-component and so on). In some aspects, the origin server 106 uses JavaScript symbols to have unique keys that can be used to mark a particular component's tracking metadata alongside a given view framework's render specific data.

The origin server 106 can distribute pre-rendered HTML and corresponding mappings to the edge servers 104. The edge servers 104 are specialized servers located at the periphery of the network 108, closer to user devices 102, to reduce latency and improve the speed of data delivery to the user devices 102. The edge servers 104 can act as intermediaries between the origin server 106 and user devices 102 by caching content, processing requests, and handling some computations locally. By offloading traffic from the origin server 106 and providing faster access to frequently requested data, the edge servers 104 enhance the performance of web services and minimize bandwidth usage.

When each edge server 104 receives pre-rendered HTML and a corresponding mapping from the origin server 106, the edge server 104 stores the pre-rendered HTML and the corresponding mapping in its local cache 112 (e.g., the local cache 112A of the edge server 104A and the local cache 112B of the edge server 104B). This can include storing in its local cache 112 any script for execution on user devices 102 to render content using the mapping to replace markers in the pre-rendered HTML with tracking metadata.

When a user device 102 requests content, depending on the network configuration, the request is routed to an edge server 104 or the origin server 106. For instance, an application 110 (e.g., a browser) on a user device 102 could send an HTTP or HTTPS request to a server, including details like the URL, query parameters, headers, and cookies. In some aspects, the receiving server uses this information to construct a cache key, a unique identifier for cached content, which could be derived from the URL and other relevant factors such as headers or cookies. The receiving server then searches its cache for a matching key; if found, the cached content is returned to the user device 102. In accordance with aspects of the technology described herein, the cached content comprises pre-rendered HTML and a corresponding mapping.

When the requesting user device 102 receives the pre-rendered HTML and corresponding mapping, the application 110 on the user device 102 renders content using the pre-rendered HTML and corresponding mapping. The pre-rendered HTML includes markers in place of tracking metadata as attributes of interactive elements, and the mapping provides information to replace these markers with the appropriate elements of the tracking metadata.

Upon receiving the pre-rendered HTML and the mapping, the application 110 on the user device 102 can parse the pre-rendered HTML. As markers within the pre-rendered HTML are encountered, the application 110 refers to the mapping to identify the corresponding tracking metadata element for each marker. The application 110 replaces each marker with the appropriate tracking metadata, ensuring that the interactive elements are correctly annotated. This process allows the application 110 to render the content accurately and efficiently. In some aspects, the application 110 performs this process of replacing markers with tracking metadata from the mapping by executing a script embedded in or otherwise provided for the pre-rendered HTML.

To further optimize performance, in some aspects, the application 110 on the user device 102 can utilize web workers to handle the process of replacing markers with tracking metadata. Web workers run in the background, separate from the main execution thread of the application 110, allowing the user device 102 to perform this task without impacting the responsiveness of the user interface. For instance, the application 110 on the user device 102 could execute a script from the pre-rendered HTML to initialize a web worker (e.g., an inline web work via the Blob and createObjectUrl APIs). The construction or the recreation of the tracking metadata's representation occurs within this web worker using the mapping. This offloads processing for the tracking metadata from the main thread of the application 110. As the tracking metadata is recreated and streamed back, it is applied back to the respective interactive elements. By offloading this process to web workers, the application 110 can maintain a smooth and responsive user experience while efficiently incorporating the tracking metadata into the content.

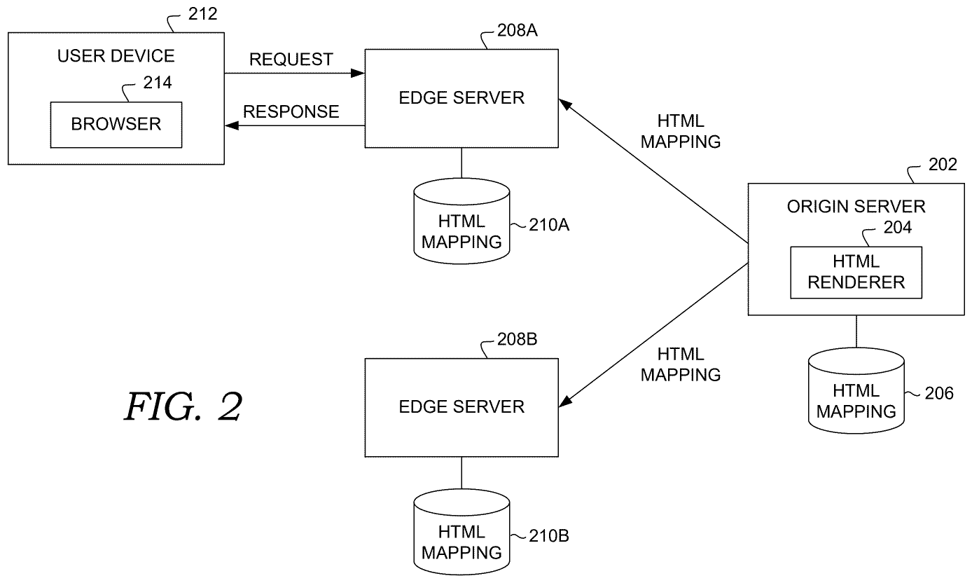

Turning next to FIG. 2, a block diagram is provided illustrating an example process of generating, caching, and serving pre-rendered HTML and corresponding mappings in accordance with some aspects of the technology described herein. As shown in FIG. 2, an origin server 202 (which can correspond to the origin server 106 of FIG. 1) includes an HTML renderer 204. Given data for web content including tracking metadata, the HTML renderer 204 generates pre-rendered HTML with markers in place of tracking metadata as attributes of interactive elements. A mapping between the markers and corresponding tracking metadata elements is also generated. The pre-rendered HTML and mapping are stored in the cache 206 of the origin server 202.

The origin server 202 transmits the pre-rendered HTML and mapping to edge servers, including the edge server 208A and the edge server 208B (which can correspond to the edge servers 104 in FIG. 1). Each edge server 208 stores the pre-rendered HTML and mapping in its local cache 210 (e.g., the local cache 210A of the edge server 208A and the local cached 210B of the edge server 208B).

In the present example, a browser 214 on a user device 212 (which can correspond to a user device 102 in FIG. 1), issues a request for content, which is routed to the edge server 208A. The request could be routed to the edge server 208A (as opposed to other edge servers 208 or the origin server 202) based on, for instance, DNS resolution, load balancing, proximity and latency optimization, and failover. Based on the request, the edge server 208A retrieves the pre-rendered HTML and mapping from its cache 210A, and provides a response to the user device 212 that includes the pre-rendered HTML and mapping. The browser 214 renders content using the mapping to replace markers in the pre-rendered HTML with tracking metadata, and the content is provided for display by the user device 212. For instance, the browser 214 could execute a script embedded in the pre-rendered HTML to replace the markers with tracking metadata. In some instances, the browser 214 uses web workers to perform this replacement process.

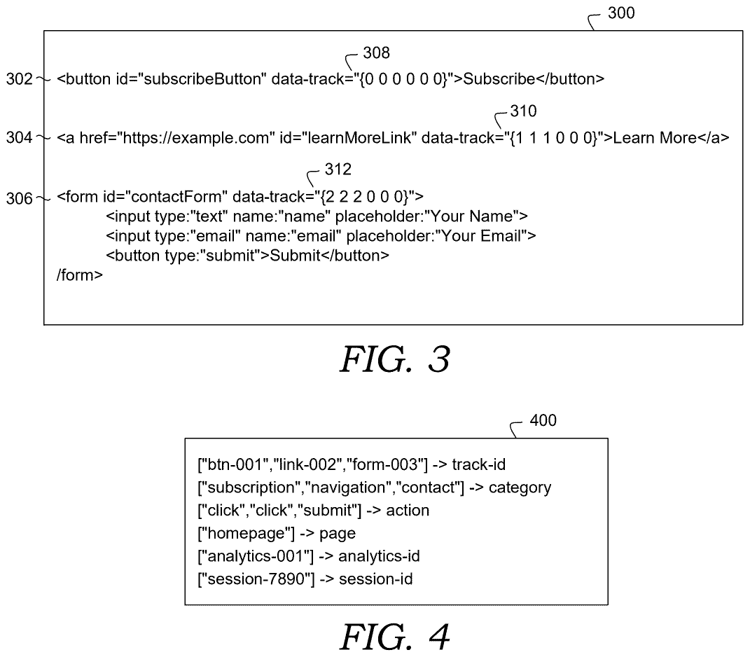

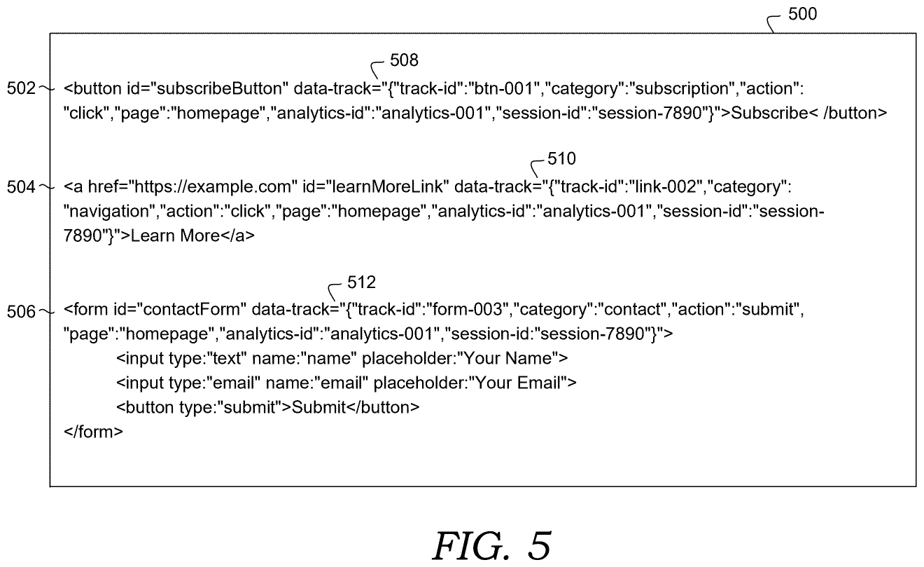

FIGS. 3-5 provide examples to illustrate aspects of the present technology. In particular, FIG. 3 provides a simple example of pre-rendered HTML 300 that includes markers in place of tracking metadata. FIG. 4 provides a simple example of a mapping 400 for the pre-rendered HTML 300 in FIG. 3. FIG. 5 provides a simple example of HTML 500 generated by replacing the markers in the pre-rendered HTML 300 in FIG. 3 with tracking metadata using the mapping 400 in FIG. 4.

As shown in FIG. 3, the pre-rendered HTML 300 includes three interactive elements—a button interactive element 302, a link interactive element 304, and a form interactive element 306. Each of the interactive elements includes a tracking attribute that has markers in place of the actual tracking metadata. For instance, the button interactive element 302 includes the tracking attribute 308 (data-track=“{0 0 0 0 0 0}”); the link interactive element 304 includes the tracking attribute 310 (data-track=“{1 1 1 0 0 0}”); and the form interactive element 306 includes the tracking attribute 312 (data-track=“{2 2 2 0 0 0}”). In this example, each number in the tracking attribute for each interactive element serves as a marker. For instance, the markers for the button interactive element 302 includes a sequence of six zeros.

The mapping 400 in this example comprises a serialized tracking data object in which the tracking metadata has been serialized. The elements of the tracking metadata comprise attribute-value pairs for the following attributes: “track-id”, “category”, “action”, “page”, “analytics-id”, and “session-id”. The mapping 400 provides possible attribute values for each of these attributes. For instance, the attribute values for the “track-id” attribute are “btn-001”, “link-002”, and “form-003”. As such, each element of the tracking metadata is an attribute-value pair. For instance, the tracking metadata elements for the “track-id” attribute are “track-id”:“btn-001”, “track-id”:“link-002”, and “track-id”:“form-003”).

In this example, the tracking attributes and the markers of each interactive element in FIG. 3 use positional encoding. In particular, the position of each marker in a tracking attribute corresponds to an attribute from the mapping 400. For instance, the marker in the first position of a tracking attribute corresponds to the “track-id” attribute, the marker in the second position corresponds to the “category” attribute, the marker in the third position corresponds to the “action” attributes, the marker in the fourth position corresponds to the “page” attribute, the marker in the fifth position corresponds to the “analytics-id” attribute, and the marker in the sixth position corresponds to the “session-id” attribute. The value of each marker for a given attribute corresponds to a position in the attribute values available for that given attribute. For instance, a “0” marker in the 0^{th} position of a tracking attribute refers to the attribute value at the 0^{th} index for the “track-id” attribute (i.e., “btn-001”), a “1” marker in the 0^{th} position of a tracking attribute refers to the attribute value at the 1^{st} index for the “track-id” attribute (i.e., “link-002”), and a “2” marker in the 0^{th} position of a tracking attribute refers to the attribute value at the 2^{nd} index for the “track-id” attribute (i.e., “form-003”).

FIG. 5 illustrates an example of HTML 500 provided as a result of replacing the markers on the tracking attributes in the pre-rendered HTML 300 with tracking metadata from the mapping 400. The HTML 500 includes three interactive elements with corresponding tracking attributes—a button interactive element 502 that includes a tracking attribute 508, a link interactive element 504 that includes a tracking attribute 510, and a form interactive element 506 that includes a tracking attribute 512. As can be seen from FIG. 5, each marker in the pre-rendered HTML 300 has been replaced with a tracking metadata element (i.e., an attribute-value pair) from the mapping 400 based on the value of the marker and the marker's position in the tracking attribute. For instance, the tracking attribute 508 for the button interactive element 502 includes the attribute-value pair “track-id”:“btn-001” in place of the “0” marker in the 0th position of the tracking attribute 308 from the pre-rendered HTML 300.

As can be seen from this example, the tracking metadata is serialized and stored only once in the mapping 400, while the pre-rendered HTML 300 contains markers, which are small encoded references to the tracking metadata in the mapping. While FIGS. 3-5 provide an example using position encoding, it should be understood that aspects of the technology described herein can use other approaches for mapping markers to corresponding tracking metadata elements. Additionally, while FIGS. 3-5 provide an example in which each marker in the pre-rendered HTML 300 corresponds with a single attribute-value pair from the mapping 400, a marker can correspond to a combination of multiple attribute-value pairs. This can further reduce the data size of pre-rendered HTML when tracking attributes of interactive elements share the same values for a number of attributes. For instance, the button interactive element 502, the link interactive element 504, and the form interactive element share the same values for the “page”, “analytics-id”, and “session-id” attributes. Accordingly, instead of using three markers for these three attribute-value pairs, a single marker could be used that references a combination of the three-attribute value pairs (i.e., a single marker would reference: “page”:“homepage”,“analytics-id”:“analytics-001”,“session-id”:“session-7890”). Additionally, the same marker referencing the combination of attribute-value pairs would be shared by the tracking attributes of the interactive elements.

### Example Methods for Optimizing Tracking Metadata in Cached HTML

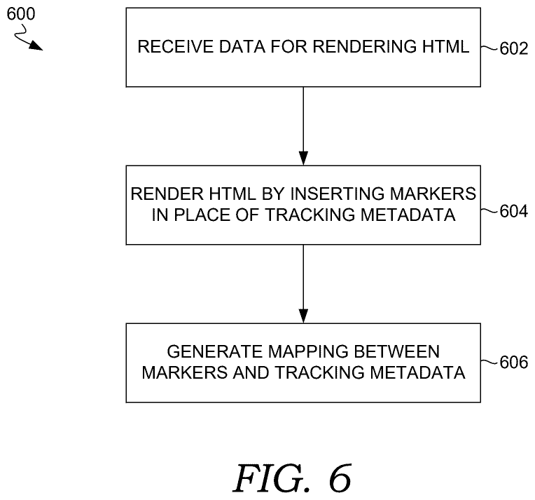

With reference now to FIG. 6, a flow diagram is provided that illustrates a method 600 for server-side HTML rendering to provide pre-rendered HTML with markers in place of tracking metadata and a mapping between the markers and the tracking metadata. The method 600 can be performed, for instance, by the origin server 106 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, a server accesses data for rendering HTML. This data can include, for instance: content, layout information, and metadata required for tracking user interactions (i.e., tracking metadata). The data can be accessed through API calls, database queries, or other data retrieval mechanisms. The server processes this data to prepare for rendering, for instance, by verifying all information has been accessed for generating the HTML.

As shown at block 604, the server renders HTML using the received data to provide pre-rendered HTML. As part of this, instead of embedding the tracking metadata directly into the pre-rendered HTML, the server inserts markers as attributes of interactive elements. These markers serve as placeholders for the tracking metadata. The server also generates a mapping between the inserted markers and corresponding elements of the tracking metadata, as shown at block 606. In some aspects, this is performed simultaneously with the rendering of the pre-rendered HTML. The mapping can be stored in various formats, such as JSON or XML, and can be embedded within the pre-rendered HTML or can be separate from the pre-rendered HTML.

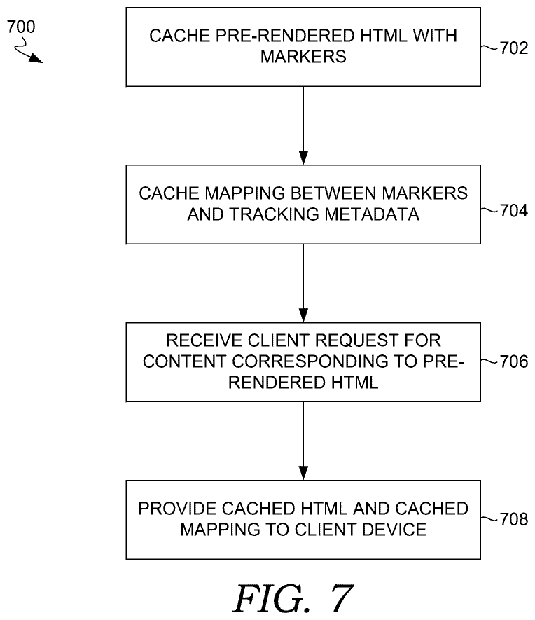

Turning next to FIG. 7, a flow diagram is provided that shows a method 700 for caching and serving pre-rendered HTML and a corresponding mapping. The method 700 can be performed, for instance, by an edge server 104 or the origin server 106 of FIG. 1.

As shown at block 702, a server stores pre-rendered HTML in a local cache. The pre-rendered HTML includes markers in place of tracking metadata as attributes of interactive elements. The server also stores a mapping for the pre-rendered HTML in the local cache, as shown at block 704. The mapping identifies tracking metadata elements corresponding to markers in the pre-rendered HTML. The mapping can be embedded in the pre-rendered HTML or separate. In the case of an origin server, the origin server stores the pre-rendered HTML and mapping in its local cache after generating them. In the case of an edge server, the edge server receives the pre-rendered HTML and mapping from an origin server and caches them in its local cache.

The server receives, from a client device, a request for content corresponding to the pre-rendered HTML, as shown at block 706. For instance, a browser on the client device could request a web page using a URL for the web page. In response to the request, the server identifies the corresponding pre-rendered HTML and associated mapping in its cache, and the server provides the pre-rendered HTML and associated mapping to the client device at block 708, such that the client device can render the content for presentation.

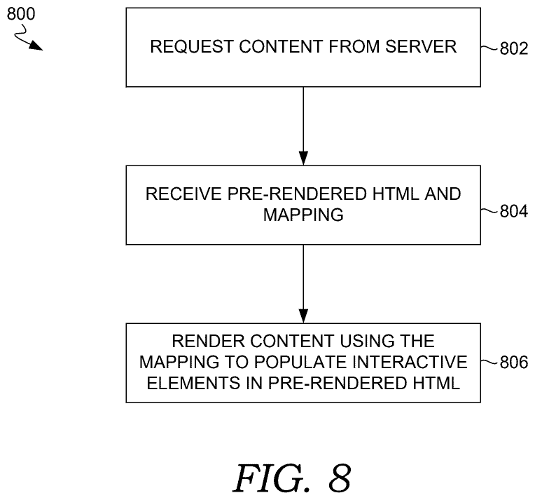

FIG. 8 provides a flow diagram showing a method 800 for a client device to render content using pre-rendered HTML and a corresponding mapping. The method 800 can be performed, for instance, by a user device 102 of FIG. 1.

As shown at block 802, the client device requests content from a server. For instance, a browser on the client device could request a web page using a URL for the web page. In response to the request, the client device receives pre-rendered HTML and an associated mapping, as shown at block 804. The pre-rendered HTML includes markers in place of tracking metadata as attributes of interactive elements, and the mapping identifies tracking metadata elements corresponding to the markers in the pre-rendered HTML.

The client device renders content using the pre-rendered HTML and the mapping, as shown at block 806. As part of this process, the client device uses the received mapping to replace the markers in the pre-rendered HTML with tracking metadata. This could involve, for instance, parsing the pre-rendered HTML to identify the markers, and substituting them with the corresponding tracking metadata elements based on the mapping. The client device can then present the rendered content. When a user interacts with interactive elements in the content, the tracking metadata needed to track the user interaction is included in the underlying attributes for the interactive elements, thereby ensuring that tracking metadata payloads are reliably delivered to tracking systems for those user interactions.

### Exemplary Operating Environment

Having described implementations of the present disclosure, an exemplary operating environment in which embodiments of the present technology can be implemented is described below in order to provide a general context for various aspects of the present disclosure. Referring initially to FIG. 9 in particular, an exemplary operating environment for implementing embodiments of the present technology is shown and designated generally as computing device 900. Computing device 900 is but one example of a suitable computing environment and is not intended to suggest any limitation as to the scope of use or functionality of the technology. Neither should the computing device 900 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what can be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 9 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory can be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which can be built in. Illustrative components include a microphone, joystick, game pad, satellite dish, scanner, printer, wireless device, etc. The I/O components 920 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 900. The computing device 900 can be equipped with depth cameras, such as, stereoscopic camera systems, infrared camera systems, RGB camera systems, and combinations of these for gesture detection and recognition. Additionally, the computing device 900 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/of” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1: One or more computer storage media storing computer-useable instructions that, when used by one or more computing devices, cause the one or more computing devices to perform operations, the operations comprising: caching, on a server, pre-rendered HTML having markers embedded as attributes of interactive elements in place of tracking metadata; caching, on the server, a mapping between the markers and the tracking metadata; receiving, over a network, a request from a client device for content corresponding to the pre-rendered HTML; and responsive to the request, providing, over the network to the client device, the pre-rendered HTML and the mapping, wherein the client device renders the content for presentation on the client device using the pre-rendered HTML by populating the interactive elements in the pre-rendered HTML with the tracking metadata using the mapping.

Clause 2: Clause 1, wherein the mapping is embedded in the pre-rendered HTML.

Clause 3: Any of Clauses 1-2, wherein a script is embedded in the pre-rendered HTML that is executed by the client device causing the client device to populate the interactive elements in the pre-rendered HTML with the tracking metadata using the mapping.

Clause 4: Any of Clauses 1-3, wherein the markers were generated and embedded in the pre-rendered HTML when the pre-rendered HTML was rendered.

Clause 5: Clause 4, wherein the mapping was generated when the pre-rendered HTML was rendered.

Clause 6: Clause 5, wherein the server is an edge server or an application server, and wherein the pre-rendered HTML and the mapping are received by the server from an origin server that rendered the pre-rendered HTML and generated the mapping.

Clause 7: Any of Clauses 1-6, wherein one or more web workers on the client device populate the interactive elements in the pre-rendered HTML with the tracking metadata by replacing the markers in the pre-rendered HTML with the tracking metadata.

Clause 8: Any of Clauses 1-7, wherein the mapping includes a first marker mapped to a combination of tracking metadata elements from the tracking metadata, and wherein the first marker is embedded in at least two of the interactive elements in the pre-rendered HTML.

Clause 9: A computer-implemented method comprising: communicating a request for content from a client device over a network to a server; in response to the request, receiving pre-rendered HTML and a mapping at the client device, the pre-rendered HTML having markers embedded as attributes of interactive elements in place of tracking metadata and the mapping identifying the tracking metadata corresponding to the markers; and rendering the content on the client device using the pre-rendered HTML and the mapping, wherein the client device uses the mapping to populate the interactive elements from the pre-rendered HTML with the tracking metadata.

Clause 10: Clause 9, wherein the mapping is embedded in the pre-rendered HTML.

Clause 11: Any of Clauses 9-10, wherein a script is embedded in the pre-rendered HTML that is executed on the client device causing the client device to populate the interactive elements in the pre-rendered HTML with the tracking metadata using the mapping.

Clause 12: Any of Clauses 9-11, wherein the markers were generated and embedded in the pre-rendered HTML when the pre-rendered HTML was rendered.

Clause 13: Clause 12, wherein the mapping was generated when the pre-rendered HTML was rendered.

Clause 14: Clause 13, wherein the server is an edge server or an application server, and wherein the pre-rendered HTML and the mapping are received by the server from an origin server that rendered the pre-rendered HTML and generated the mapping.

Clause 15: Any of Clauses 9-14, wherein one or more web workers on the client device populate the interactive elements in the pre-rendered HTML with the tracking metadata by replacing the markers in the pre-rendered HTML with the tracking metadata.

Clause 16: Any of Clauses 9-15, wherein the mapping includes a first marker mapped to a combination of tracking metadata elements from the tracking metadata, and wherein the first marker is embedded in at least two of the interactive elements in the pre-rendered HTML.

Clause 17: A computer system comprising: an origin server that generates pre-rendered HTML and a mapping, the pre-rendered HTML including markers in place of tracking metadata as attributes of interactive elements, the mapping associating the tracking metadata with the markers; and a plurality of edge servers in communication with the origin server over a network, each edge server receiving the pre-rendered HTML and the mapping from the origin server, storing the pre-rendered HTML and the mapping in a local cache, and responding to requests for content from client devices by providing the pre-rendered HTML and the mapping to the client devices.

Clause 18: Clause 17, wherein the origin server generates and embeds the markers in the pre-rendered HTML and generates the mapping when generating the pre-rendered HTML.

Clause 19: Any of Clauses 17-18, wherein the computer system further comprises: a first client device that receives the pre-rendered HTML and mapping from a first edge server in response to a request for content, and renders the content by replacing the markers in the pre-rendered HTML with the tracking metadata using the mapping.

Clause 20: Any of Clauses 17-19, wherein the origin server embeds the mapping and a script in the pre-rendered HTML, and wherein the script is executed by an application on the first client device to cause the application to replace the markers in the pre-rendered HTML with the tracking metadata using the mapping.

What is claimed is:

1. One or more computer storage media storing computer-useable instructions that, when used by one or more computing devices, cause the one or more computing devices to perform operations, the operations comprising:
caching, on a server, pre-rendered HTML having markers embedded as attributes of interactive elements in place of tracking metadata;
caching, on the server, a mapping between the markers and the tracking metadata;
receiving, over a network, a request from a client device for content corresponding to the pre-rendered HTML; and
responsive to the request, providing, over the network to the client device, the pre-rendered HTML and the mapping, wherein the client device renders the content for presentation on the client device using the pre-rendered HTML by populating the interactive elements in the pre-rendered HTML with the tracking metadata using the mapping.

2. The one or more computer storage media of claim 1, wherein the mapping is embedded in the pre-rendered HTML.

3. The one or more computer storage media of claim 1, wherein a script is embedded in the pre-rendered HTML that is executed by the client device causing the client device to populate the interactive elements in the pre-rendered HTML with the tracking metadata using the mapping.

4. The one or more computer storage media of claim 1, wherein the markers were generated and embedded in the pre-rendered HTML when the pre-rendered HTML was rendered.

5. The one or more computer storage media of claim 4, wherein the mapping was generated when the pre-rendered HTML was rendered.

6. The one or more computer storage media of claim 5, wherein the server is an edge server or an application server, and wherein the pre-rendered HTML and the mapping are received by the server from an origin server that rendered the pre-rendered HTML and generated the mapping.

7. The one or more computer storage media of claim 1, wherein one or more web workers on the client device populate the interactive elements in the pre-rendered HTML with the tracking metadata by replacing the markers in the pre-rendered HTML with the tracking metadata.

8. The one or more computer storage media of claim 1, wherein the mapping includes a first marker mapped to a combination of tracking metadata elements from the tracking metadata, and wherein the first marker is embedded in at least two of the interactive elements in the pre-rendered HTML.

9. A computer-implemented method comprising:
communicating a request for content from a client device over a network to a server;
in response to the request, receiving pre-rendered HTML and a mapping at the client device, the pre-rendered HTML having markers embedded as attributes of interactive elements in place of tracking metadata and the mapping identifying the tracking metadata corresponding to the markers; and
rendering the content on the client device using the pre-rendered HTML and the mapping, wherein the client device uses the mapping to populate the interactive elements from the pre-rendered HTML with the tracking metadata.

10. The computer-implemented method of claim 9, wherein the mapping is embedded in the pre-rendered HTML.

11. The computer-implemented method of claim 9, wherein a script is embedded in the pre-rendered HTML that is executed on the client device causing the client device to populate the interactive elements in the pre-rendered HTML with the tracking metadata using the mapping.

12. The computer-implemented method of claim 9, wherein the markers were generated and embedded in the pre-rendered HTML when the pre-rendered HTML was rendered.

13. The computer-implemented method of claim 12, wherein the mapping was generated when the pre-rendered HTML was rendered.

14. The computer-implemented method of claim 13, wherein the server is an edge server or an application server, and wherein the pre-rendered HTML and the mapping are received by the server from an origin server that rendered the pre-rendered HTML and generated the mapping.

15. The computer-implemented method of claim 9, wherein one or more web workers on the client device populate the interactive elements in the pre-rendered HTML with the tracking metadata by replacing the markers in the pre-rendered HTML with the tracking metadata.

16. The computer-implemented method of claim 9, wherein the mapping includes a first marker mapped to a combination of tracking metadata elements from the tracking metadata, and wherein the first marker is embedded in at least two of the interactive elements in the pre-rendered HTML.

17. A computer system comprising:
an origin server that generates pre-rendered HTML and a mapping, the pre-rendered HTML including markers in place of tracking metadata as attributes of interactive elements, the mapping associating the tracking metadata with the markers; and
a plurality of edge servers in communication with the origin server over a network, each edge server receiving the pre-rendered HTML and the mapping from the origin server, storing the pre-rendered HTML and the mapping in a local cache, and responding to requests for content from client devices by providing the pre-rendered HTML and the mapping to the client devices.

18. The computer system of claim 17, wherein the origin server generates and embeds the markers in the pre-rendered HTML and generates the mapping when generating the pre-rendered HTML.

19. The computer system of claim 17, wherein the computer system further comprises:
a first client device that receives the pre-rendered HTML and mapping from a first edge server in response to a request for content, and renders the content by replacing the markers in the pre-rendered HTML with the tracking metadata using the mapping.

20. The computer system of claim 19, wherein the origin server embeds the mapping and a script in the pre-rendered HTML, and wherein the script is executed by an application on the first client device to cause the application to replace the markers in the pre-rendered HTML with the tracking metadata using the mapping.
